(19) United States
(12) Patent Application Publication
(10) Pub. No.: US 2011/0225759 A1
(43) Pub. Date: Sep. 22, 2011

(54) CONTAINER, A TOOTHBRUSH, A USE OF A CONTAINER AND A METHOD TO APPLY A TOOTH CLEANING SUBSTANCE AND A PLAQUE INDICATING SUBSTANCE ON A TOOTHBRUSH

(75) Inventor: Esther Hermina Adriana Fleuren, Hilversum (NL)

(73) Assignee: EF DENTAL CARE B.V., Hilversum (NL)

(21) Appl. No.: 13/125,171

(22) PCT Filed: Oct. 20, 2008
(86) PCT No.: PCT/NL2008/000232

§ 371 Date: May 6, 2011

(51) Int. Cl. A46B 9/04; B65D 25/00; B67D 7/00

(52) U.S. Cl. 15/167.1; 222/1; 220/500; 222/145.1

(57) ABSTRACT

The invention relates to a use of a container comprising at least two separate compartments wherein a first compartment comprises a plaque indicating substance, and a second compartment comprises a tooth cleaning substance, for applying the plaque indicating substance and the tooth cleaning substance to a toothbrush, such that the visible surface area of the plaque indicating substance on the toothbrush is larger than the visible surface area of the tooth cleaning substance on the toothbrush. The invention also relates to a method for applying a plaque indicating substance and a tooth cleaning substance to a toothbrush, a container comprising at least two separate compartments, a first compartment comprising a tooth cleaning substance, and a second compartment comprising a plaque indicating substance, and a toothbrush comprising a body of bristles, which defines a contact surface, the toothbrush further comprising a product body on the contact surface, wherein the product body comprises a tooth cleaning substance and a plaque indicating substance.

### CROSS-REFERENCE TO RELATED APPLICATIONS

This application is the National Stage of International Application No. PCT/NL2008/000232, filed Oct. 20, 2008, the contents of which is incorporated by reference herein.

### FIELD OF THE INVENTION

The present invention relates to a use of a container comprising at least two separate compartments, wherein a first compartment comprises a plaque indicating substance and a second compartment comprises a tooth cleaning substance, for applying the plaque indicating substance and the tooth cleaning substance to a toothbrush.

The invention further relates to a method for applying a plaque indicating substance and a tooth cleaning substance to a toothbrush using a container comprising at least two separate compartments, wherein a first compartment comprises a plaque indicating substance, and a second compartment comprises a tooth cleaning substance.

The invention also relates to a container comprising at least two separate compartments, wherein a first compartment comprises a plaque indicating substance, and a second compartment comprises a tooth cleaning substance.

### BACKGROUND OF THE INVENTION

Plaque indicating substances are known to identify dental plaque on teeth by colouring the plaque. Colouring of the plaque is desirable, because plaque is normally difficult to see. Normally, the plaque is removed from the teeth using a tooth cleaning substance, preferably tooth paste. The colouring of the plaque aids in effectively removing the plaque, because a person using the plaque indicating substance will be encouraged to clean his teeth with the tooth cleaning substance until all coloured plaque is removed.

The plaque indicating substance can be administered to the mouth in various ways, including a tablet, a pastil, in gel form, on swabs, or in a solution in water. Also combinations with the tooth cleaning substance are known, such that the administration of the plaque indicating substance and the tooth cleaning substance to the mouth is substantially simultaneously.

GB 2.274.061 discloses a tooth cleaning substance in combination with a plaque indicating substance. The substances may be combined and dispensed from a container or may be contained, prior to use, in two separate compartments of a container and combined on dispensing from the container. GB 2.274.061 also discloses a container having two separate compartments, one compartment containing the tooth cleaning substance, and the other compartment containing the plaque indicating substance. The two compartments have a common exit through which the contents of the two compartments are dispensed. Thus, in use, the tooth cleaning substance and the plaque indicating substance are applied at the same time.

However, it has been found by the applicant that administering both the tooth cleaning substance and the plaque indicating substance at a same time does not always effectively colour the dental plaque. This was demonstrated in tests by first using a combination of a tooth cleaning substance and a plaque indicating substance. After removal of the coloured plaque only an additional plaque indicating substance was administered to the mouth. If the colouring of the initial plaque indicating substance would have been effective, there would not be any remaining plaque which would be coloured. However, it was found that in most cases, the administration of the additional plaque indicating substance after removal of the coloured plaque still revealed some remaining plaque areas.

The applicant found that a cause for this problem is that during the application of the substances the tooth cleaning substance can get in the way of the plaque indicating substance by covering some of the plaque when both substances are simultaneously spread throughout the mouth, thereby preventing the plaque indicating substance to colour all the plaque, and leaving a substantial portion of the plaque uncoloured. For this reason the product of GB 2.274.061 does not satisfy the need of users.

### SUMMARY OF THE INVENTION

It is an object of the invention to increase the effectiveness of a plaque indicating substance in combination with a tooth cleaning substance.

The invention therefore provides a use of a container according to the present invention. Most toothbrushes have a body of bristles, which defines a contact surface to which substances can be applied. The visible surface area of a substance is the outer surface area of the substance that can thus be seen by a person. When the visible surface area of the plaque indicating substance on the toothbrush is larger, preferably substantially larger than the visible surface area of the tooth cleaning substance, the plaque indicating substance will mainly be the first substance to contact the teeth and thereby more effectively colour the dental plaque, because the tooth cleaning substance can not get in the way of the plaque indicating substance when both substances are spread throughout the mouth. Thus, the plaque indicating substance engages the relevant areas before the tooth cleaning substance has an opportunity to cover these areas and prevent the plaque indicating substance to engage the relevant areas.

The invention thus results in a first time period in which the plaque indicating substance contacts the teeth and a second, subsequent time period in which the tooth cleaning substance contacts the teeth. Although these time periods may overlap somewhat the major part of the teeth is coloured by the plaque indicating substance before the tooth cleaning substance contacts the teeth.

In an embodiment, the plaque indicating substance and the tooth cleaning substance form an elongate product body on the toothbrush, preferably parallel to a longitudinal axis of the contact surface of the toothbrush. The product body has longitudinal sides which are substantially defined by the plaque indicating substance. In a variant, multiple strands of plaque indicating substance and at least one strand of tooth cleaning substance are provided on the toothbrush, said strands forming a layer on the toothbrush, and wherein the outer strands of the layer are plaque indicating substance.

Commonly, people using a toothbrush will keep the toothbrush initially in an orientation such that a longitudinal axis of the contact surface of the toothbrush is substantially parallel with a row of teeth present in the mouth of a person. As a result, the longitudinal sides of the contact surface of the toothbrush are the first areas which contact the top row of teeth and the bottom row of teeth respectively. When the longitudinal sides of the contact surface are mainly covered with plaque indicating surface, the plaque indicating surface will mainly be the first substance to contact the teeth and be spread around the mouth, thereby increasing the effectiveness of the plaque indicating substance.

Preferably, the tooth cleaning substance is applied on top of the toothbrush, and the plaque indicating substance is substantially applied on top of the tooth cleaning substance. In a variant, the tooth cleaning substance is applied on top of the toothbrush, and the plaque indicating substance is applied substantially on top of and adjacent to the tooth cleaning substance. In yet another variant, a layer of plaque indicating substance is provided on top of a layer of tooth cleaning substance. In another embodiment, the plaque indicating substance substantially forms an inverted U-form which lies over the tooth cleaning substance, as seen in cross-sectional view. Preferably, there is no or substantially no visible surface area of the tooth cleaning substance on the toothbrush. The above variants and embodiments further ensure that mainly the plaque indicating substance is the first substance to contact the teeth, thereby further increasing the effectiveness of the plaque indicating substance.

In an embodiment, the plaque indicating substance and tooth cleaning substance form an elongate product body on the toothbrush, the product body being substantially symmetrical with respect to a plane through the centre of the product body defined by a longitudinal axis of the product body and a direction perpendicular to the contact surface of the toothbrush. The direction perpendicular to the contact surface of the toothbrush will be parallel to the bristles of the toothbrush.

In an embodiment, the volume of the applied plaque indicating substance is more than 50% of the total volume of substance applied to the toothbrush. This ensures that there is enough plaque indicating substance to colour all the plaque which subsequently may be removed by the tooth cleaning substance. In a variant, the volume of the plaque indicating substance is at least ⅔ of the total volume of substance applied to the toothbrush.

In another embodiment, the viscosity of the plaque indicating substance is smaller, preferably substantially smaller, than the viscosity of the tooth cleaning substance. Due to the smaller viscosity of the plaque indicating substance compared to the tooth cleaning substance, the plaque indicating substance will spread more easily through the mouth. In a preferred embodiment, the viscosity is such that the tooth cleaning substance starts to spread through the mouth after a significant amount of plaque indicating substance has been spread through the mouth. This further increases the effectiveness of the plaque indicating substance and may result in a reduction of required plaque indicating substance, such that less than 50% of the total volume of substance applied to the toothbrush may be plaque indicating substance.

The invention also relates to a container according to an embodiment of the present invention.

In an embodiment, the container comprises at least two discharge openings, each discharge opening being in communication with one of the at least two separate compartments. This has the advantage that the plaque indicating substance and the tooth cleaning substance remain separate until discharging from the container, thereby preventing the two substances to mix, which further increases the effectiveness of the plaque indicating substance.

In an embodiment, the at least two openings are arranged adjacent to each other in the direction of a longitudinal axis of the container.

In another embodiment, the container has a longitudinal axis and the discharge openings define a discharge direction, wherein the discharge direction is oriented substantially perpendicular to the longitudinal axis. This provides a natural handling of the container, such that the substances can be applied to the toothbrush without uncomfortably twisting an arm or hand of a person using the container. Preferably, the discharge openings are located near an end of the container, thereby indicating that this end of the container should be held upwards, which aids in a comfortable and/or natural handling of the container.

Preferably, the container is positioned in use such that the discharge opening of the plaque indicating substance is located substantially above the discharge opening of the tooth cleaning substance. This has the advantage that the toothbrush can be held in a natural comfortable position, i.e. the contact surface of the toothbrush facing upwards, by a user while the user applies the substances to the toothbrush.

In a preferred embodiment, the discharge openings are oriented substantially perpendicular to the longitudinal axis of the container and located near an end of the container, such that the opening of the plaque indicating substance is closer to said end than the opening of the tooth cleaning substance.

In another embodiment, the tooth cleaning substance and the plaque indicating substance are applied simultaneously, preferably by a pump. This has the advantage, especially for children, that a user can not “forget” to apply the plaque indicating substance. Preferably, one pump is used to dispense the tooth cleaning substance and the plaque indicating substance, but more than one pump is also envisaged, for example, a pump for each substance. The pump may be a hand pump, but other pumps, like a gas-operated pump can also be used. Preferably, the pump dispenses a predetermined amount of tooth cleaning substance and a predetermined amount of plaque indicating substance when operated. The pump is preferably manually operated.

In yet another embodiment the pumps are adjustable such that the predetermined amount of tooth cleaning substance or plaque indicating substance can be changed. This allows optimizing either the total amount of substance, and/or the ratio between tooth cleaning substance and plaque indicating substance. Children do not require as much total substance as adults, because the surface area of the teeth of children is normally smaller than the surface area of the teeth of adults.

In an embodiment, the container comprises a protruding nozzle, wherein the discharge openings are provided in the protruding nozzle. The nozzle preferably extends in an inclined orientation, preferably in the direction of another end, which can be the bottom of the container. It is also possible that the nozzle only extends in an inclined orientation during the discharging of the plaque indicating substance and the tooth cleaning substance from the container.

In another embodiment of the invention, the at least one opening communicating with the compartment comprising the plaque indicating substance has a larger opening area than the at least one opening communicating with the compartment comprising the tooth cleaning substance. In this way, the discharged amount of plaque indicating substance is bigger than the discharged amount of the tooth cleaning substance. However, it is also possible to adjust the ratio between the sizes of the at least one discharge openings to compensate for viscosity differences between the plaque indicating substance and the tooth cleaning substance. In a possible example, the viscosity of the two substances can be substantially different, but the discharge openings can be arranged such that they compensate for this difference and an equal amount of plaque indicating substance and tooth cleaning substance can be discharged.

In an embodiment of the invention, the viscosity of the substances is such that they more or less settle after dispensing from the container. It is therefore not necessary that the shape of the openings corresponds to the shape of the applied substances. It is possible for example that the openings are located above each other, so that according to the shape of the openings it is expected that the plaque indicating substance will be applied on top of the tooth cleaning substance only, but that due to the viscosity of the plaque indicating substance, this substance will flow over the edge of the tooth cleaning substance and thereby forms an inverted U-form. In that case, it is preferred that the viscosity of the plaque indicating substance is smaller than the viscosity of the tooth cleaning substance, but other ratio's between viscosities are also possible, depending amongst others on the required shape of the individual layers.

In yet another embodiment, the container further comprises an indicator indicating the preferred orientation of the container with respect to a toothbrush. The indicator will assist the user when using the container to keep the container in a preferred position with respect to the toothbrush. Indicators can be signs or markers on the outside of the container, but also a level may be included in the container. Other indicators are also envisaged.

In another embodiment, the container may comprise means to position a toothbrush in a preferred orientation with respect to the container. Examples of such means are a plateau or a socket or the like attached to the container, wherein the toothbrush is able to rest against or in the plateau or socket, thereby positioning the toothbrush with respect to the container. Other means can be for instance connection means, which attach the toothbrush, e.g. temporarily, to the container. Also an integral combination of a toothbrush and a container is possible, wherein the toothbrush and container are always in a preferred orientation with respect to the each other.

The present invention also provides a method according to an embodiment of the present invention and a toothbrush according to an embodiment of the present invention.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

In the drawing,

FIGS. 1A-1E show cross-sectional views of a toothbrush on which plaque indicating substance and tooth cleaning substance are applied according to an embodiment of the invention,

FIGS. 2A-2D show top views of product bodies comprising tooth cleaning substance and plaque indicating substance according to other embodiments of the invention,

FIG. 3 shows a container according to yet another embodiment of the invention,

FIG. 4 shows a container according to another embodiment of the invention,

FIG. 5 shows a side view of another embodiment of the container according to the invention,

FIGS. 6A-6E show variants of the discharge openings of the container as viewed in the direction of arrow A in FIG. 4.

### DETAILED DESCRIPTION OF THE INVENTION

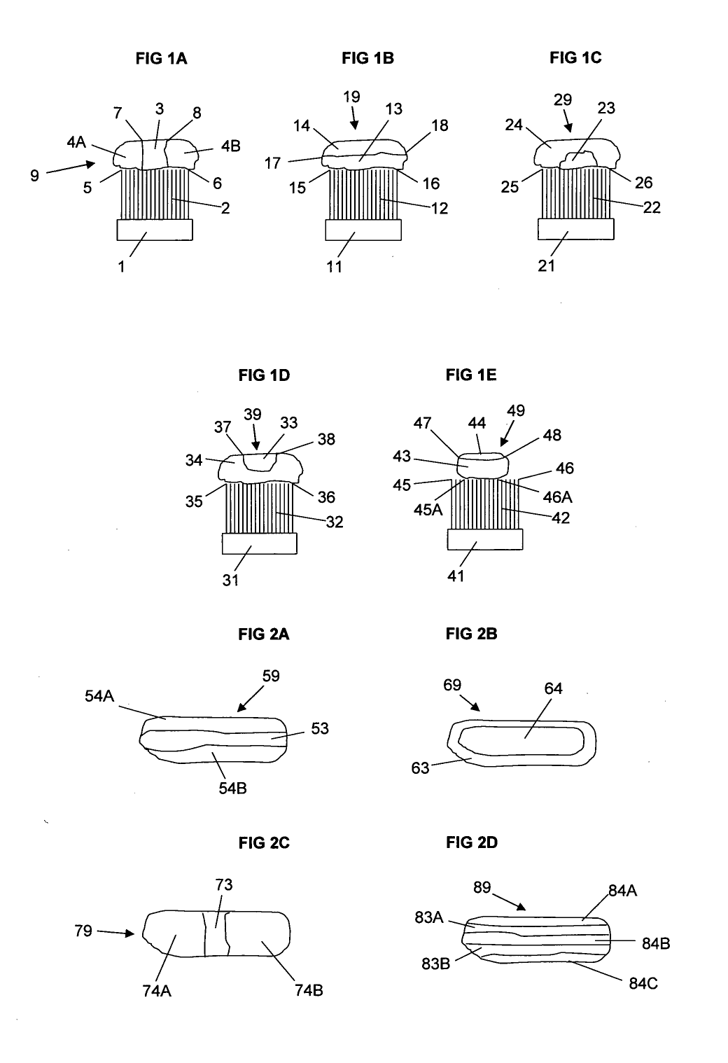

FIG. 1A shows a cross-sectional view of a toothbrush in longitudinal direction. The toothbrush comprises a solid portion 1 and a body of bristles 2 on top of the solid portion 1. The body of bristles 2 defines a contact surface between longitudinal edges 5 and 6 of the body of bristles 2 to which substances can be applied.

In this embodiment, three strands 3, 4A, and 4B are applied on the contact surface forming a product body 9 on top of the toothbrush in the form of a layer. Strand 4A is located on the left side of the toothbrush, strand 4B is located on the right side of the toothbrush, and strand 3 is applied in the middle between strand 4A and 4B. The strand 3 comprises a tooth cleaning substance and the strands 4A and 4B comprise a plaque indicating substance. On the outer surface of the product body 9 facing away from the toothbrush, two transition areas 7 and 8 can be distinguished, the transition areas 7, 8 defining the locations on the outer surface of the product body 9 where the plaque indicating substance is adjacent to the tooth cleaning substance.

The outer surface areas between edge 5 and transition area 7, between transition area 7 and transition area 8, and between transition area 8 and edge 6 is a visible surface area which can easily be seen by a user. The surface area of the product body 9 facing the contact surface between edges 5 and 6 can not easily be seen by a user due to the bristle body 2 and therefore is not part of the visible surface area. The visible surface area can also be defined as being the surface area of the product body 9 that initially gets into contact with the teeth of a user in normal use or the surface area facing away from the toothbrush.

In this embodiment, the visible surface area of the plaque indicating substance on the toothbrush, being the surface area between edge 5 and transition area 7 and between transition area 8 and edge 6, is larger than the visible surface area of the tooth cleaning substance 3, being the surface area between transition areas 7 and 8. In this way, the effectiveness of the plaque indicating substance is increased, because when the product body 9 is administered to the mouth of a user, mainly the plaque indicating substance will be the first substance getting into contact with the teeth of the user. The plaque indicating substance is then able to effectively colour the dental plaque, since less tooth cleaning substance may be in the way of the plaque indicating substance.

An additional advantage of the plaque indicating substance being on the longitudinal sides of the toothbrush (left and right side of the toothbrush), is that these areas are normally the first areas getting into contact with a top row of teeth and a bottom row of teeth when the product body 9 is administered to the mouth parallel to a row of teeth.

FIG. 1B shows a toothbrush to which a product body 19 is applied according to an alternative embodiment of the invention. The toothbrush has a solid portion 11 and a body of bristles 12 on top of the solid body 11. The body of bristles 12 defines a contact surface between longitudinal edges 15 and 16 of the body of bristles 12 to which substances can be applied.

The product body 19, comprising two layers 13, 14, has been applied on top of the contact surface. Layer 13 comprises tooth cleaning substance and layer 14 comprises plaque indicating substance. The tooth cleaning substance is provided on top of the contact surface, and the plaque indicating substance 14 is applied on top of the tooth cleaning substance. The visible surface area is the outer surface area of the product body facing away from the toothbrush between edges 15 and 16. As can be seen, the visible area of the plaque indicating substance, being the surface area between transition area 17 and transition area 18, is approximately 65-80% of the total visible area. Therefore, the plaque indicating substance will be the first substance getting into contact with the teeth of a user.

FIG. 1C depicts a toothbrush to which a product body 29 has been applied according to another embodiment of the invention. The toothbrush has a solid portion 21 and a body of bristles 22 on top of the solid body 21. The body of bristles 22 defines a contact surface between longitudinal edges 25 and 26 of the body of bristles 22 to which substances can be applied.

In this embodiment, the product body 29, which has been applied to the contact surface, comprises a layer 23 of tooth cleaning substance and a layer 24 of plaque indicating substance on top of and adjacent to the tooth cleaning substance, thereby substantially forming an inverted U-form, which lies over the tooth cleaning substance.

The visible surface area, being the outer surface area of the product body 29 between edges 25 and 26 facing away from the toothbrush, comprises in this embodiment only surface area of the plaque indicating substance. As a result the first substance getting into contact with the teeth will be the plaque indicating substance when the plaque indicating substance and the tooth cleaning substance are applied to the mouth of the user.

FIG. 1D depicts a toothbrush to which a product body 39 has been applied according to yet another embodiment of the invention. The toothbrush has a solid portion 31 and a body of bristles 32 on top of the solid body 31. The body of bristles 32 defines a contact surface between longitudinal edges 35 and 36 of the body of bristles 32 to which substances can be applied.

In this embodiment, the product body 39, which has been applied to the contact surface, comprises a substantially U-shaped layer 34 of plaque indicating substance, with between the legs of the U-shape a layer 33 of tooth cleaning substance.

The visible surface area is the outer surface area of the product body 39 facing away from the toothbrush between edges 35 and 36. As can be seen, the visible area of the plaque indicating substance, being the surface area between transition area 37 and transition area 38, is approximately 55-75% of the total visible area. Therefore, the plaque indicating substance will mainly be the first substance getting into contact with the teeth of a user.

Similar to the product body 9 of FIG. 1A, the longitudinal sides of the product body 39 (being on the right side and left side of the toothbrush) are defined by plaque indicating substance having the additional advantage that these areas are normally the first areas getting into contact with a top row of teeth and a bottom row of teeth when the product body 39 is administered to the mouth parallel to a row of teeth.

FIG. 1E depicts a toothbrush to which a product body 49 has been applied according to a further embodiment of the invention. The toothbrush has a solid portion 41 and a body of bristles 42 on top of the solid body 41. The body of bristles 42 defines a contact surface between longitudinal edges 45 and 46 of the body of bristles 42 to which substances can be applied.

In this embodiment, the product body 49, which has been applied to the contact surface, does not cover the entire contact surface.

The visible surface area is the outer surface area of the product body 49 facing away from the toothbrush between edges 45A and 46A. As can be seen, the visible area of the plaque indicating substance, being the surface area between transition area 47 and transition area 48, is approximately 50% of the total visible area.

FIG. 1E shows a product body 49 wherein substantially less than 50% of the volume of the product body is plaque indicating substance. However, if the viscosity of the plaque indicating substance is substantially smaller than the viscosity of the tooth cleaning substance the plaque indicating substance will spread more easily due to the smaller viscosity when the user administers the product body to the mouth. After the plaque indicating substance has been mainly spread throughout the mouth, the tooth cleaning substance will start to spread through the mouth, thereby ensuring that despite the small amount and relatively small visible surface area of the plaque indicating substance the plaque indicating substance is mainly the first substance to get into contact with the teeth.

The product bodies 9, 29, 39 of FIGS. 1A, 1C, and 1D have in common that more than 50% of the volume of the product body 9, 29, 39, in particular approximately ⅔ of the volume comprises plaque indicating substance. In FIG. 1B, approximately 50% of the volume of the product body 19 is plaque indicating substance. The presence of more plaque indicating substance aids in getting the plaque indicating substance to be mainly the first substance getting into contact with the teeth of a user. It also ensures that there is enough plaque indicating substance to colour all the plaque.

The product bodies 9, 19, 29, 39, 49 of FIGS. 1A-1E also have in common that they are substantially symmetrical with respect to a plane through the centre of the product body 9, 19, 29, 39, 49, said plane being defined by a longitudinal direction of the product body 9, 19, 29, 39, 49 and a direction perpendicular to the contact surface of the toothbrush. Although, the symmetry is not required, it has the advantage that there is a reduced difference between the administration of the product body 9, 19, 29, 39, 49 to the mouth by a left handed person and a right handed person.

FIG. 2A-2D show product bodies 59, 69, 79, 89 as applied to a toothbrush (not shown) similar to the product bodies 9, 19, 29, 39, 49 of FIGS. 1A-1E, but now seen from a side opposite the toothbrush and perpendicular to the contact surface of the toothbrush to which the product body 59, 69, 79, 89 has been applied. This side of the product body 59, 69, 79, 89 will face the teeth of a user when the user administers the product body 59, 69, 79, 89 to the mouth.

FIG. 2A shows a product body 59 comprising a strand 53 of tooth cleaning substance and two strands 54A and 54B of plaque indicating substance. In case of two separate strands 54A, 54B of plaque indicating substance, the product body 59 is similar to the product body 9 of FIG. 1A. It is however possible, that the two strands 54A, 54B are connected with each other below the strand 53 of tooth cleaning substance, the product body 59 is then similar to the product body 39 of FIG. 1D. The surface area of the plaque indicating substance is larger than the surface area of the tooth cleaning substance, thereby causing the plaque indicating substance to mainly be the first substance getting into contact with the teeth of a user.

The product body 59 is an elongate product body 59 having longitudinal sides which are in this case defined by the plaque indicating substance. The longitudinal sides are in use most of the time parallel to the row of teeth of a user, thereby the longitudinal sides will be the first areas to get into contact with respectively the top and bottom row of teeth. Therefore, the plaque indicating substance will mainly be the first substance to get into contact with the teeth, thereby increasing the effectiveness of the plaque indicating substance.

In FIG. 2B is shown a variant of a product body 69. The side facing away from the toothbrush has in this embodiment an inner portion 64 comprising plaque indicating substance, and an outer portion 63 comprising tooth cleaning substance. It is possible that the tooth cleaning substance surrounds the plaque indicating substance, but it is also possible that the tooth cleaning substance and the plaque indicating substance form two layers, wherein the plaque indicating substance is on top of the tooth cleaning substance.

FIG. 2C shows another variant of a product body 79, wherein the ends 74A and 74B of the product body 79 comprise plaque indicating substance, and the centre 73 of the product body 79 comprises tooth cleaning substance. The distribution of the substances is such that the surface area of the plaque indicating substance 74A, 74B is larger than the surface area of the tooth cleaning substance.

FIG. 2D shows a product body 89 comprising five strands, the outer strands 84A, 84C, and the middle strand 84B comprise plaque indicating substance. In between the plaque indicating substance, two strands 83A, 83B of tooth cleaning substance are provided.

The product bodies 9, 19, 29, 39, 49, 59, 69, 79, 89 of the FIG. 1A-1E and 2A-2D can be applied to a toothbrush by a container comprising at least two separate compartments, wherein a first compartment comprises a plaque indicating substance, and a second compartment comprises a tooth cleaning substance. It is also possible that the toothbrush itself comprises at least two separate compartments, wherein a first compartment comprises a plaque indicating substance, and a second compartment comprises a tooth cleaning substance.

It is further noted that the product bodies of FIGS. 1A-1E and 2A-2D can be dispensed from openings that are in communication with the at least two separate compartments. The shape/orientation of the openings and the viscosities of the tooth cleaning substance and the plaque indicating substance respectively determine amongst others the way in which the product body is formed. Especially due to the viscosity it is possible that a cross sectional view of the applied product body does not correspond to the shape of the openings. For example, the shape of the openings and their orientation may correspond to a product body according substantially to FIG. 1E or 1B, but the viscosity of the plaque indicating substance can be such that it will fall off the edges of the tooth cleaning substance layer, thereby forming a product body substantially according to FIG. 1C.

A person skilled in the art will therefore acknowledge that the shape of the applied product body can or may change during the application on the toothbrush or after it has been applied. The product bodies of FIG. 1A-1E and 2A-2D are shown in their position as they will be applied to the mouth and are therefore not necessarily corresponding to the initial product body as dispensed from the container.

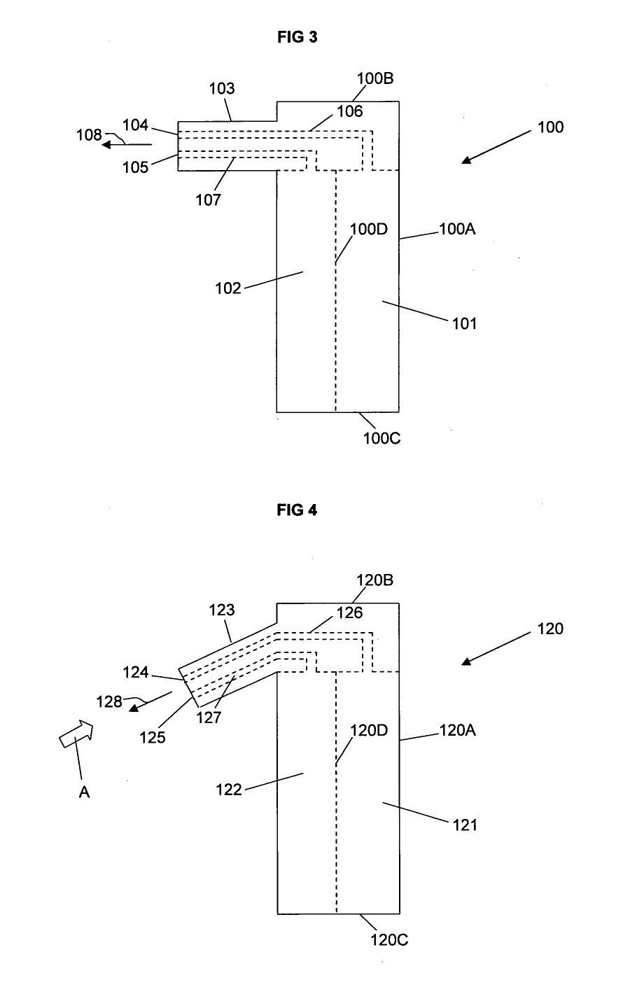

FIG. 3 shows an example of a container 100 according to an embodiment of the invention. The container 100 comprises a housing 100A, and within the housing 100A two compartments 101 and 102 which are separated from each other by a wall 100D. Preferably, the compartment 101 comprises plaque indicating substance, and the compartment 102 comprises tooth cleaning substance. The housing 100A can have a substantially cylindrical shape, but other shapes are also possible. The container 100 further has a top end 100B and a bottom end 100C.

Near the top end 100B, the container 100 comprises a protruding nozzle 103. Discharge openings 104 and 105 are provided in the nozzle 103, said openings 104, 105 being in fluid communication with compartments 101 and 102 through conduits 106 and 107 respectively.

The discharge openings 104, 105 define a discharge direction, here represented by arrow 108. The discharge direction 108 in this embodiment is perpendicular to a longitudinal axis of the container 100. It is also possible that the discharge direction 108 has an inclined orientation in the direction of the bottom end 100C of the container 100.

In normal use, a user will grab the housing 100A below the protruding nozzle 103. The discharge opening 104 communicating with the plaque indicating substance is than above the discharge opening 105 communicating with the tooth cleaning substance. A toothbrush (not shown) can be held naturally near the discharge openings with its contact surface facing upwards. In this way, the tooth cleaning substance will be applied on top of the toothbrush, and the plaque indicating substance will be applied on top of the tooth cleaning substance, thereby forming, for example, a product body according to any of the FIGS. 1B, 1C, 1E or 2B.

The substances can be discharged from the container 100 by squeezing the housing 100A, but also a pump, preferably a hand pump can be used to discharge the substances. It is further possible, that a pump for each substance is provided. It is also possible that in case of more than one pump, the pumps can be adjusted in order to change the amount of substance that is discharged.

FIG. 4 shows another example of a container 120 according to an embodiment of the invention. The container 120 comprises a housing 120A, and within the housing 120A two compartments 121 and 122 which are separated from each other by a wall 120D. Preferably, the compartment 121 comprises plaque indicating substance, and the compartment 122 comprises tooth cleaning substance. The housing 120A can have a substantially cylindrical shape, but other shapes are also possible. The container 120 further has a top end 120B and a bottom end 120C.

Near the top end 120B, the container 120A comprises a protruding nozzle 103. Discharge openings 124 and 125 are provided in the nozzle 123, said openings 124, 125 being in fluid communication with compartments 121 and 122 through conduits 126 and 127 respectively. The nozzle can be a removable part of the container, thereby allowing an easy cleaning of the nozzle, or easier access to the compartments for a possible refill. The removable nozzle also allows to change the nozzle and thereby change the way the substances are discharged from the containers, or the ratio between the discharged substances. It is further possible to change the predetermined amount of substances that are discharged when the container is operated, thereby allowing to adapt to the different needs between for instance a child and an adult.

The discharge openings 124, 125 define a discharge direction, here represented by arrow 128. The discharge direction 128 in this embodiment is inclined with respect to a longitudinal axis of the container 120 in direction of the bottom end 120C.

In normal use, a user will grab the housing 120A below the protruding nozzle 123. The discharge opening 124 communicating with the plaque indicating substance is than above the discharge opening 125 communicating with the tooth cleaning substance. A toothbrush (not shown) can be held naturally near the discharge openings with its contact surface facing upwards. In this way, the tooth cleaning substance will be applied on top of the toothbrush, and the plaque indicating substance will be applied on top of the tooth cleaning substance, thereby forming, for example, a product body according to any of the FIGS. 1B, 1C, 1E or 2B. However, other shapes and sizes of the discharge openings 124 and 125 are also possible to discharge the substances in any preferred pattern on a toothbrush.

The substances can be discharged from the container 120 by squeezing the housing 120A, but also a pump, preferably a hand pump can be used to discharge the substances. It is further possible, that a pump for each substance is provided. It is also possible that in case of more than one pump, the pumps can be adjusted in order to change the amount of substance that is discharged.

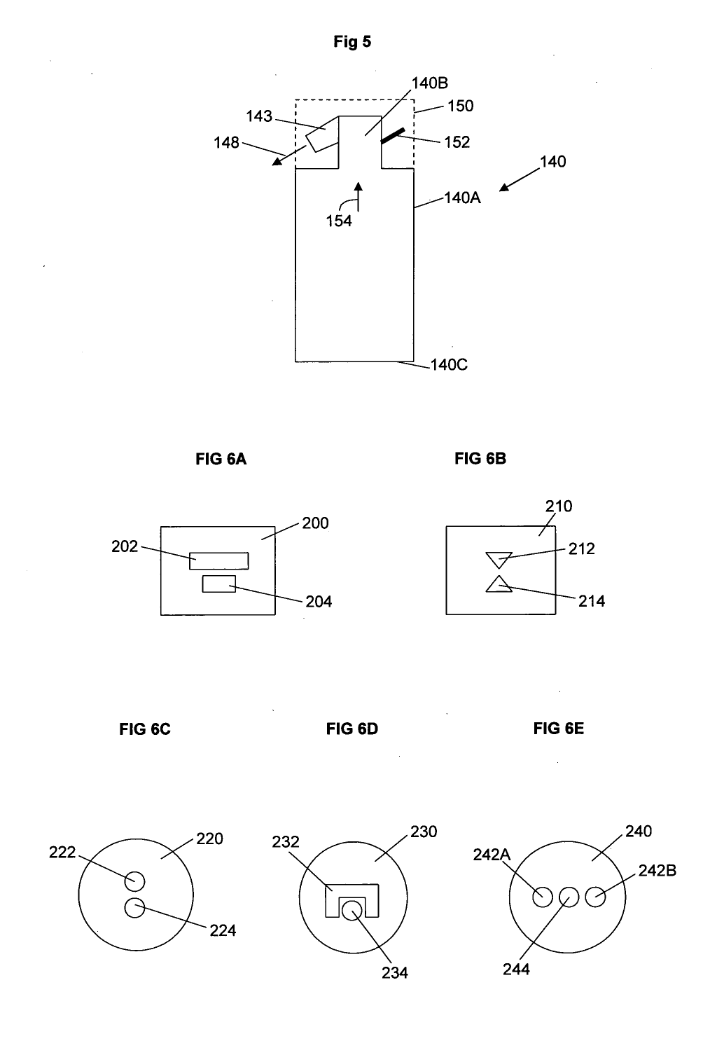

FIG. 5 shows a container 140 according to another embodiment of the invention. The container 140 comprises a housing 140A. Inside the housing 140A, the container 140 comprises at least two separate compartments storing plaque indicating substance and tooth cleaning substance separately from each other. This interior may be the same as in the embodiments of FIGS. 3 and 4. The container 140 further has a top end 140B and a bottom end 140C.

Near the top end 140B, the container 140 comprises a protruding nozzle 143 having discharge openings (not shown) to discharge the tooth cleaning substance and the plaque indicating substance. The protruding nozzle 143 in this embodiment is attached to the top end 140B by a simple click system. This has the advantage that the protruding nozzle can be separated from the container housing 140A to clean the discharge openings or to change between different protruding nozzles depending on the user. Seen from above, the protruding nozzle 143 does not extend beyond the exterior of the housing 140A. This allows a cap 150, here drawn with a dotted line, to be placed over the top end 140B and the protruding nozzle 143. This is advantageous from a hygiene point of view.

Opposite to the protruding nozzle 143, the top end 140B comprises a lever 152 that can be manually operated. Pressing the lever 152 will discharge the substances from the container. This embodiment shows a hand pump principle, but other pumping principles can also be used. Preferably, the pump is adjustable to control the amount of tooth cleaning substance and/or the amount of plaque indicating substance. It is possible that the pump can be adjusted to control the total amount and/or the ratio between the two substances. It is also possible that the container 140 comprises two pumps or more, for each compartment one.

The container 140 shows an example of an indicator that can be used to indicate to a user how the container could be used. In this case, the indicator is a simple arrow 154 that represents: this side up. Other indicators are also possible such as a level.

FIG. 6A shows an example of how discharge openings can be arranged on a container. In FIG. 6A is shown one end 200 of a protruding nozzle. This end 200 has two discharge openings 202 and 204. Depending on the viscosity and the required product body, one of the discharge openings is in fluid communication with a compartment holding tooth cleaning substance and the other the other discharge opening is in fluid communication with a compartment holding plaque indicating substance. In this example, the discharge openings are rectangular and discharge opening 202 is larger than discharge opening 204. With these discharge openings it is possible to apply product bodies according to FIG. 1B, 1C, 1E, 2A, or 2B.

FIG. 6B shows another example of how discharge openings can be arranged on the container. In FIG. 6B is shown one end 210 of a protruding nozzle, although a protruding nozzle is not required. This end 210 has two discharge openings 212 and 214. Depending on the viscosity and the required product body, one of the discharge openings is in fluid communication with a compartment holding tooth cleaning substance and the other the other discharge opening is in fluid communication with a compartment holding plaque indicating substance. In this example, the discharge openings are triangular and they are equal in size. With these discharge openings it is possible to apply product bodies according to FIG. 1B, 1C, 1E, 2A, or 2B.

FIG. 6C shows yet another example of how discharge openings can be arranged on a container. In FIG. 6C is shown one end 220 of a protruding nozzle. This end 220 has two discharge openings 222 and 224. Depending on the viscosity and the required product body, one of the discharge openings is in fluid communication with a compartment holding tooth cleaning substance and the other the other discharge opening is in fluid communication with a compartment holding plaque indicating substance. In this example, the discharge openings are circular and they are equal in size. With these discharge openings it is possible to apply product bodies according to FIG. 1B, 1C, 1E, 2A, or 2B.

FIG. 6D shows a further example of how discharge openings can be arranged on a container. In FIG. 6D is shown one end 230 of a protruding nozzle. This end 230 has two discharge openings 232 and 234. Depending on the viscosity and the required product body, one of the discharge openings is in fluid communication with a compartment holding tooth cleaning substance and the other the other discharge opening is in fluid communication with a compartment holding plaque indicating substance. In this example, discharge opening 232 has an inverted U-shape, and discharge opening 234 is circular, wherein discharge opening 232 is larger than discharge opening 234. With these discharge openings it is possible to apply product bodies according to FIG. 1C, 1D, 2A, or 2C.

FIG. 6E shows another example of how discharge openings can be arranged on a container. In FIG. 6E is shown one end 240 of a protruding nozzle. This end has three discharge openings 242A, 242B and 244. Depending on the viscosity and the required product body, at least one of the discharge openings is in fluid communication with a compartment holding tooth cleaning substance and at least one of the discharge openings is in fluid communication with a compartment holding plaque indicating substance. In this example, the discharge openings are circular and they are equal in size. With these discharge openings it is possible to apply product bodies according to FIG. 1A, 2A, or 2C.

It will de understood by a person skilled in the art that many shapes and variants are possible. It is also to be understood that the shape of the discharge openings does not have to be corresponding to the eventual product body that is applied to the mouth of a user. Further, the FIGS. 6A-6E do not limit the orientation of the discharge openings as indicated in the drawings. It is possible that another orientation is preferred. The protruding nozzle referred to in the FIGS. 6A-6E does not have to be a rigid connected one, but can also be a removable nozzle that can easily be connected to and removed from the container. It is also possible that the container does not comprise a protruding nozzle, but that the discharge openings are situated in the housing of a container.

It will be understood by a person skilled in the art, that the scope of the invention is not limited to the embodiments shown in the figures. Many variants and combinations are possible and are also envisaged.

1.-17. (canceled)

18. A method for applying a plaque indicating substance and a tooth cleaning substance to a toothbrush using a container comprising at least two separate compartments, wherein a first compartment comprises a plaque indicating substance, and a second compartment comprises a tooth cleaning substance, the method comprising dispensing the tooth cleaning substance and the plaque indicating substance from the container, such that the visible surface area of the plaque indicating substance on the toothbrush is larger than the visible surface area of the tooth cleaning substance on the toothbrush.

19.-20. (canceled)

21. Method according to claim 18, wherein the tooth cleaning substance is applied on top of the toothbrush, and the plaque indicating substance is applied substantially on top of the tooth cleaning substance.

22. Method according to claim 18, wherein a layer of plaque indicating substance is provided on top of a layer of tooth cleaning substance.

23. Method according to claim 18, wherein the tooth cleaning substance is applied on top of the toothbrush, and the plaque indicating substance is applied substantially on top of and adjacent to the tooth cleaning substance.

24. Method according to claim 18, wherein the plaque indicating substance substantially forms an inverted U-form which lies over the tooth cleaning substance, as seen in cross-sectional view.

25.-27. (canceled)

28. Method according to claim 18, wherein the container comprises at least two discharge openings, each discharge opening being in communication with one of the at least two separate compartments, and wherein the container is positioned in use such that the discharge opening of the plaque indicating substance is located substantially above the discharge opening of the tooth cleaning substance.

29.-30. (canceled)

31. Method according to claim 18, wherein the tooth cleaning substance and the plaque indicating substance are dispensed from the container by a pump or by squeezing a housing of the container.

32.-34. (canceled)

35. A container for the method according to claim 18, the container comprising at least two separate compartments, a first compartment comprising a tooth cleaning substance, and a second compartment comprising a plaque indicating substance.

36. A container according to claim 35, wherein the container further comprises at least two discharge openings, each discharge opening being in fluid communication with one of the at least two compartments.

37. (canceled)

38. A container according to claim 35, wherein the at least two openings are arranged adjacent to each other in the direction of the longitudinal axis.

39. A container according to claim 35, wherein the at least one opening communicating with the compartment comprising the plaque indicating substance has a larger opening area than the at least one opening communicating with the compartment comprising the tooth cleaning substance.

40. A container according to claim 36, wherein the container comprises a protruding nozzle and wherein the discharge openings are provided in the protruding nozzle, and wherein the nozzle extends in an inclined orientation in direction of a bottom of the container.

41. A container according to claim 35, wherein the container further comprises at least one pump to dispense the tooth cleaning substance and the plaque indicating substance from the container or wherein the substances can be discharged from the container by squeezing a housing of the container.

42.-47. (canceled)

48. A toothbrush comprising a body of bristles, which defines a contact surface, the toothbrush further comprising a product body on the contact surface, wherein the product body comprises a tooth cleaning substance and a plaque indicating substance, such that the visible surface area of the plaque indicating substance on the toothbrush is larger than the visible surface area of the tooth cleaning substance on the toothbrush.

49.-57. (canceled)

58. A toothbrush comprising a body of bristles and at least two separate compartments, wherein a first compartment comprises a plaque indicating substance, and a second compartment comprises a tooth cleaning substance, said body of bristles defining a contact surface to which substances can be applied, the toothbrush further comprising discharging means to apply the plaque indicating substance and the tooth cleaning substance to the toothbrush, such that the visible surface area of the plaque indicating substance on the toothbrush is larger than the visible surface area of the tooth cleaning substance on the toothbrush.
